(19) United States
(12) Patent Application Publication
(10) Pub. No.: US 2014/0188508 A1
(43) Pub. Date: Jul. 3, 2014

(54) METHOD OF AUTOMATED ELECTRONIC HEALTH RECORD SYSTEM

(71) Applicant: Edmond Arthur DeFrank, (US)

(72) Inventor: Edmond Arthur DeFrank, (US)

(21) Appl. No.: 13/732,295

(22) Filed: Dec. 31, 2012

(51) Int. Cl. G06Q 10/10; G06Q 50/24

(52) U.S. Cl. CPC G06Q 10/10; G06Q 50/24
USPC 705/3

(57) ABSTRACT

The embodiments disclose a method of automated electronic health record system including automating the collection, recordation, storage and use patient health information and data to create an electronic health record in a secure electronic environment, using one or more automated systems to facilitate the rapid and accurate collection, storage and use of the electronic health record information and data including automated database access security measures and querying the electronic health record information and data using the one or more automated systems to prepare and process patient billing, health insurance billings and collections and cross check the electronic health record information and data with current governmental and agency compliance and other health related processing.

### CROSS-REFERENCE TO RELATED APPLICATIONS

This application is based on U.S. Provisional Patent Application Ser. No. 61/582,320 filed: Dec. 31, 2011, entitled “Method Of Automated Patient Electronic Health Record Patient Intake System”, by Edmond DeFrank; U.S. Provisional Patent Application Ser. No. 61/582,343 filed: Dec. 31, 2011, entitled “Method Of Automated Patient Electronic Health Record Patient Insurance Verification System”, by Edmond DeFrank; U.S. Provisional Patent Application Ser. No. 61/582,349 filed: Dec. 31, 2011, entitled “Method Of Automated Patient Electronic Health Record Preauthorization And Appeal Benefit Determination System”, by Edmond DeFrank; U.S. Provisional Patent Application Ser. No. 61/582,355 filed: Dec. 31, 2011, entitled “Method Of Automated Patient Electronic Health Record Billing And Coding System”, by Edmond DeFrank; U.S. Provisional Patent Application Ser. No. 61/582,359 filed: Dec. 31, 2011, entitled “Method Of Automated Patient Electronic Health Record Compliance System”, by Edmond DeFrank; U.S. Provisional Patent Application Ser. No. 61/582,364 filed: Dec. 31, 2011, entitled “Method Of Automated Patient Electronic Health Record Patient Collection System”, by Edmond DeFrank; and; U.S. Provisional Patent Application Ser. No. 61/582,340 filed: Dec. 31, 2011, entitled “Method Of Automated Gathering Of Patient Medical Records”, by Edmond DeFrank.

### BACKGROUND

Current and planned legislative laws require healthcare plans, healthcare providers, doctors, authorized health care clinicians and staff to establish electronic health records for each patient and guard the privacy of the patient information within the electronic health records. These increased legal requirements make more complex the daily tasks associated with managing the vast volumes of information gathered in the course of delivering health care services and the business aspects of providing health care services such as billing.

### BRIEF DESCRIPTION OF THE DRAWINGS

FIG. 1 shows a block diagram of an overview of a method of automated electronic health record system of one embodiment.

FIG. 2 shows a block diagram of an overview flow chart of an automated electronic health record system of one embodiment.

FIG. 3 shows a block diagram of an overview flow chart of an automated electronic capture of data of one embodiment.

FIG. 4 shows a block diagram of an overview flow chart of automated database access security measures of one embodiment.

FIG. 5A shows a block diagram of an overview flow chart of an automated patient intake system of one embodiment.

FIG. 5B shows a block diagram of an overview flow chart of an automated gathering patient medical records of one embodiment.

FIG. 6 shows a block diagram of an overview flow chart of an automated patient insurance verification system of one embodiment.

FIG. 7 shows a block diagram of an overview flow chart of an automated preauthorization and appeal benefit determination system of one embodiment.

FIG. 8 shows a block diagram of an overview flow chart of an automated electronic health billing and coding system of one embodiment.

FIG. 9 shows a block diagram of an overview flow chart of an automated electronic health billing and coding system of one embodiment.

FIG. 10 shows a block diagram of an overview flow chart of an automated compliance system of one embodiment.

FIG. 11 shows a block diagram of an overview flow chart of an automated patient collection system of one embodiment.

FIG. 12 shows a block diagram of an overview flow chart of an automated billings and collections analysis report generated of one embodiment.

FIG. 13 shows a block diagram of an overview flow chart of an automated explanation of benefits (EOB) evaluation of one embodiment.

### DETAILED DESCRIPTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the present invention.

### General Overview:

It should be noted that the descriptions that follow, for example, in terms of a method of automated electronic health record system is described for illustrative purposes and the underlying system can apply to any number and multiple types of patients, healthcare plans and healthcare information. In one embodiment the method of automated electronic health record system can be configured using digital devices such as programmable computers, scanners, storage memory devices, digital communication devices, software programming and codes. The method of automated electronic health record system can be configured to include information access security measures and monitoring devices and can be configured to include automation controls to activate digital devices automatically for uses such as optical scanning and optical character recognition using the present invention.

### Overview:

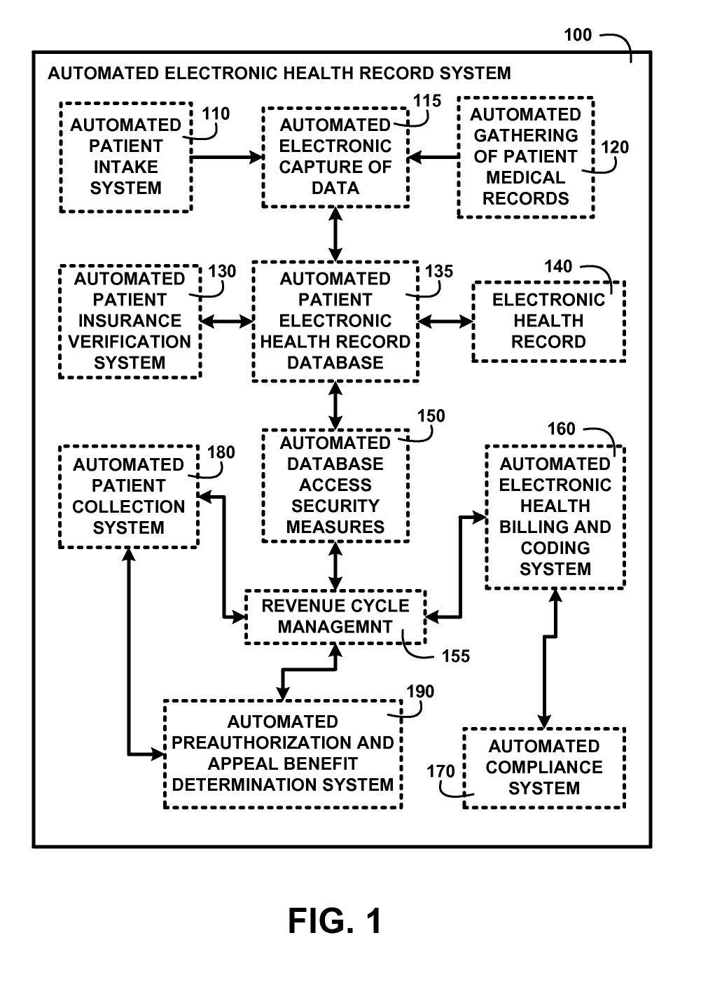

FIG. 1 shows a block diagram of an overview of a method of an automated electronic health record system of one embodiment. FIG. 1 shows an automated electronic health record system 100 used to enable a health care provider to manage the vast volume of record keeping, accounting and production of billing and collections including evaluating multiple patient health insurance policies and the demands of current and projected legislative mandate to create a secure, accessible patient electronic health record 140 (EHR). The automated electronic health record system 100 includes an automated patient intake system 110. The automated patient intake system 110 uses automated electronic capture of data 115 to begin the process of creating the patient electronic health record 140. The legislative mandates in part have a goal of creating a patient electronic health record 140 that represents a complete health record of one embodiment.

The automated electronic health record system 100 includes automated gathering of patient medical records 120 using automated electronic capture of data 115 to gather health care records from outside the current healthcare provider to add past health records to an automated patient electronic health record database 135. The automated patient electronic health record database 135 is used as the central repository of the electronic health record 140 of one embodiment.

The automated electronic health record system 100 includes an automated patient insurance verification system 130 used to confirm the current coverage, plan enrollment and benefits of a patient insurance plan. The automated electronic health record system 100 includes automated database access security measures 150 to protect the privacy of the patient information and medical records of one embodiment.

The automated electronic health record system 100 includes revenue cycle management 155 tools to create comprehensive and timely management of the financial aspects of providing health care services. The revenue cycle management 155 tools include an automated preauthorization and appeal benefit determination system 190, an automated electronic health billing and coding system 160, an automated compliance system 170 and an automated patient collection system 180 of one embodiment.

### Detailed Description:

### Automated Electronic Health Record System:

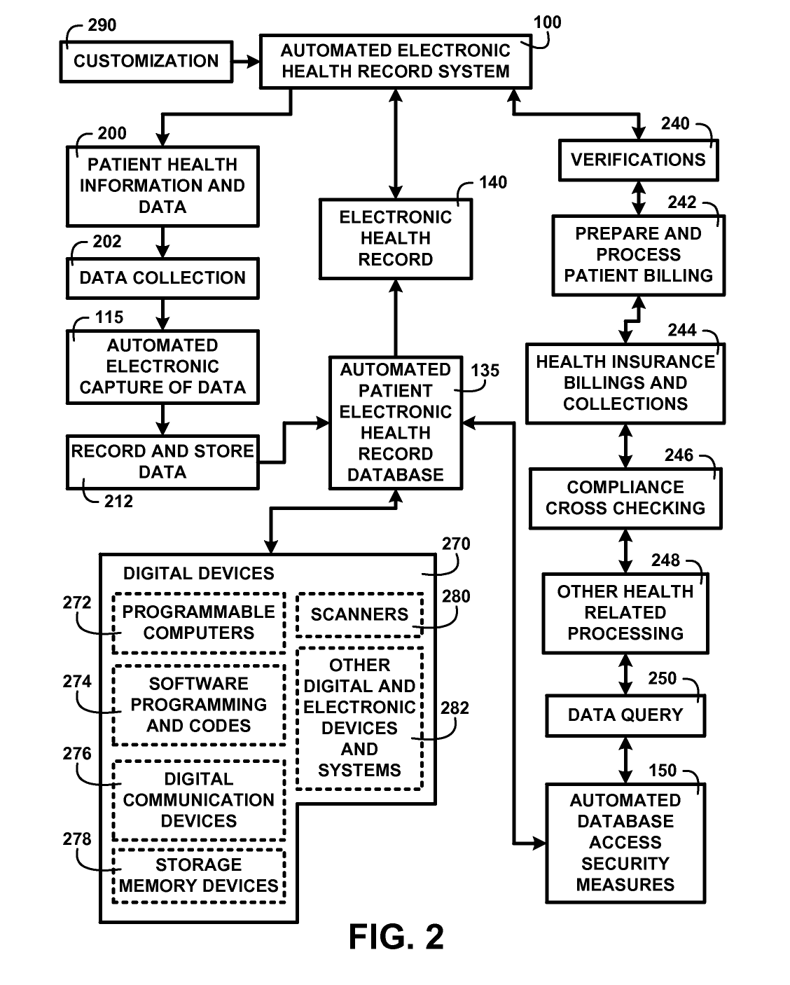

FIG. 2 shows a block diagram of an overview flow chart of an automated electronic health record system of one embodiment. FIG. 2 shows the automated electronic health record system 100 used to acquire patient health information and data 200 and data collection 202 using the automated electronic capture of data 115. The automated electronic capture of data 115 is used to record and store data 212 in the automated patient electronic health record database 135 to create an electronic health record 140 of one embodiment.

The automated electronic health record system 100 processes the automated patient electronic health record database 135 using digital devices 270 including programmable computers 272, software programming and codes 274, digital communication devices 276, storage memory devices 278, scanners 280 and other digital and electronic devices and systems 282. The digital devices 270 are used to automatically preform verifications 240, prepare and process patient billing 242 and health insurance billings and collections 244. The automated electronic health record system 100 processes compliance cross checking 246 and other health related processing 248. When a request for information is made using a data query 250 the automated database access security measures 150 protects the information in the automated patient electronic health record database 135 and only lets authorized access to the information. The automated electronic health record system 100 includes systems that can be modified using customization 290. Customization 290 includes for example input formats customized for a particular health care provider operation of one embodiment.

### Automated Electronic Capture of Data:

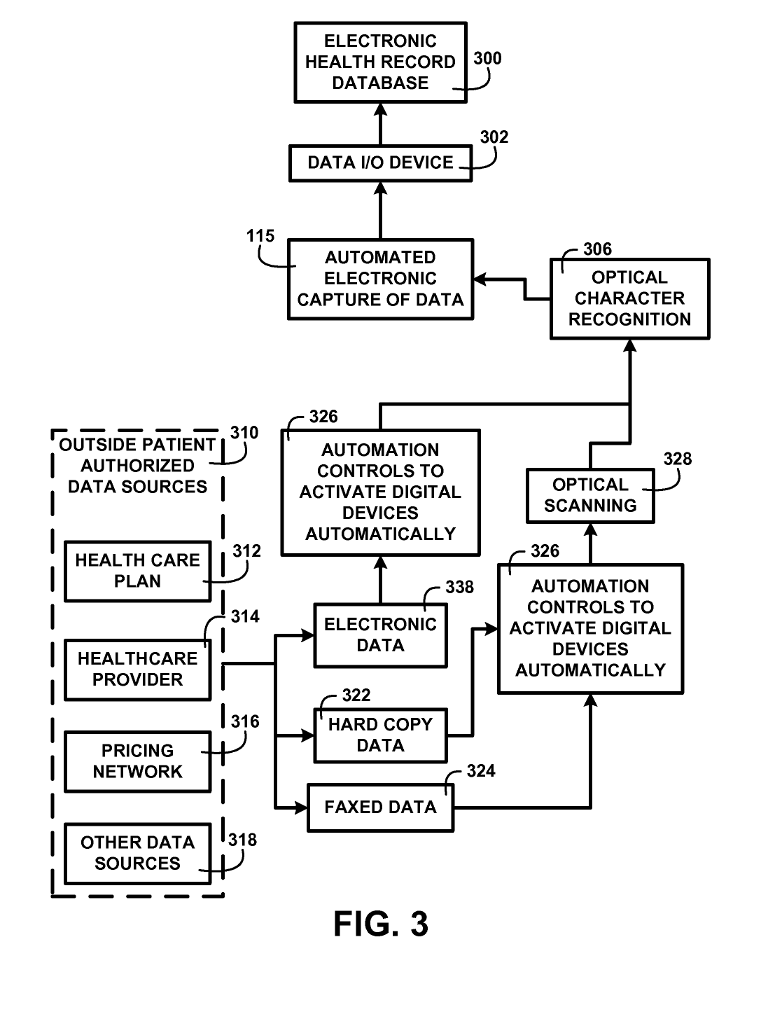

FIG. 3 shows a block diagram of an overview flow chart of an automated electronic capture of data of one embodiment. FIG. 3 shows uploading of information and data into an electronic health record database 300 using a data I/O device 302 to record the automated electronic capture of data 115. The automated electronic capture of data 115 uses optical character recognition 306 to convert into digital readable text information and data from for example outside patient authorized data sources 310. The outside patient authorized data sources 310 can be sending a health care plan 312, past medical records from a healthcare provider 314, information from a pricing network 316 and other data sources 318 of one embodiment.

The information being sent can be in the form of hard copy data 322 and faxed data 324. The automated electronic capture of data 115 uses automation controls to activate digital devices automatically 326 including for example optical scanning 328 and optical character recognition 306 to convert the information into digital readable text for recordation into the electronic health record database 300. The outside patient authorized data sources 310 can be sending electronic data 338 wherein the automated electronic capture of data 115 uses automation controls to activate digital devices automatically 326 for example optical character recognition 306 to process the electronic data 338 of one embodiment.

### Automated Database Access Security Measures:

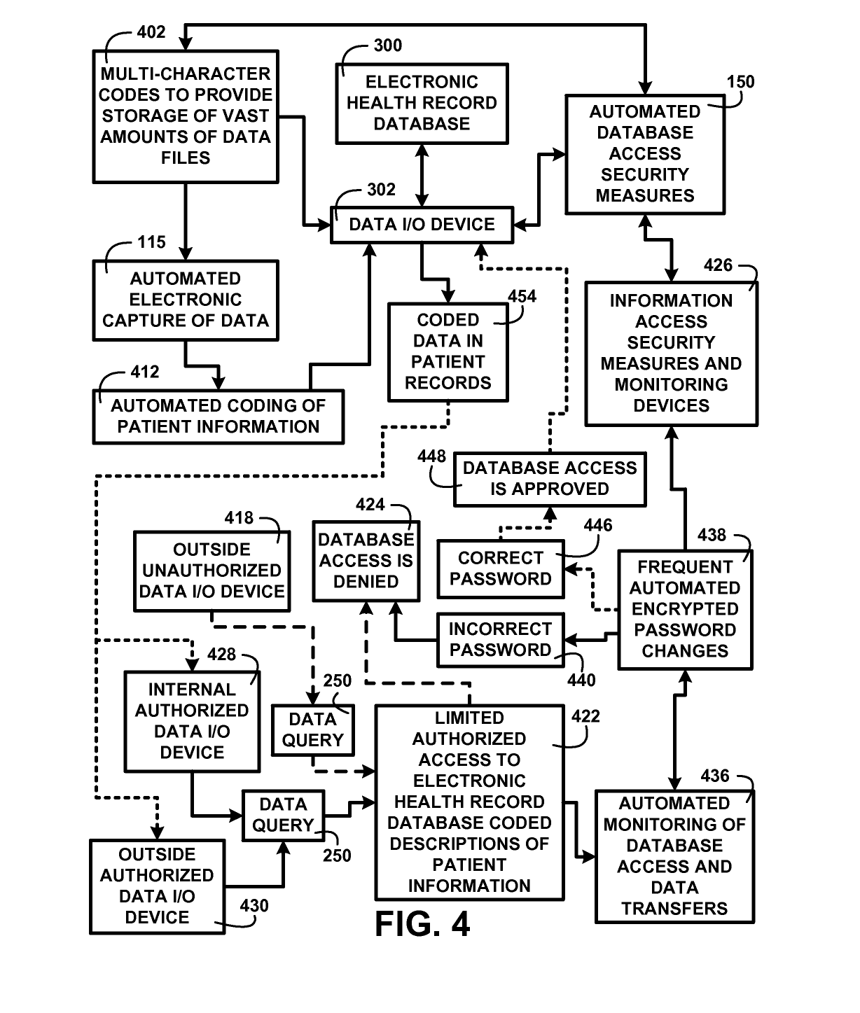

FIG. 4 shows a block diagram of an overview flow chart of automated database access security measures of one embodiment. FIG. 4 shows the automated database access security measures 150 used to create multi-character codes to provide storage of vast amounts of data files 402. A data I/O device 302 used for example in the automated electronic capture of data 115 routes the data through the automated database access security measures 150 which performs automated coding of patient information 412 for recordation in the electronic health record database 300.

When an outside unauthorized data I/O device 418 tries to perform a data query 250 the automated database access security measures 150 uses a limited authorized access to electronic health record database coded descriptions of patient information 422 features to check whether the data query 250 is from an authorized user. The outside unauthorized data I/O device 418 is not authorized and the system responds that database access is denied 424 and no data is transferred.

When an internal authorized data I/O device 428 or outside authorized data I/O device 430 performs the data query 250 the limited authorized access to electronic health record database coded descriptions of patient information 422 features confirms they are authorized. The automated database access security measures 150 performs automated monitoring of database access and data transfers 436. The automated database access security measures 150 include frequent automated encrypted password changes 438 using information access security measures and monitoring devices 426. If the user enters an incorrect password 440 database access is denied 424. If the user enters the correct password 446 database access is approved 448 and the data I/O device 302 routes the data query 250 to the electronic health record database 300. The electronic health record database 300 transmits the coded data in patient records 454 to the requesting internal authorized data I/O device 428 or outside authorized data I/O device 430 of one embodiment.

### Automated Patient Intake System:

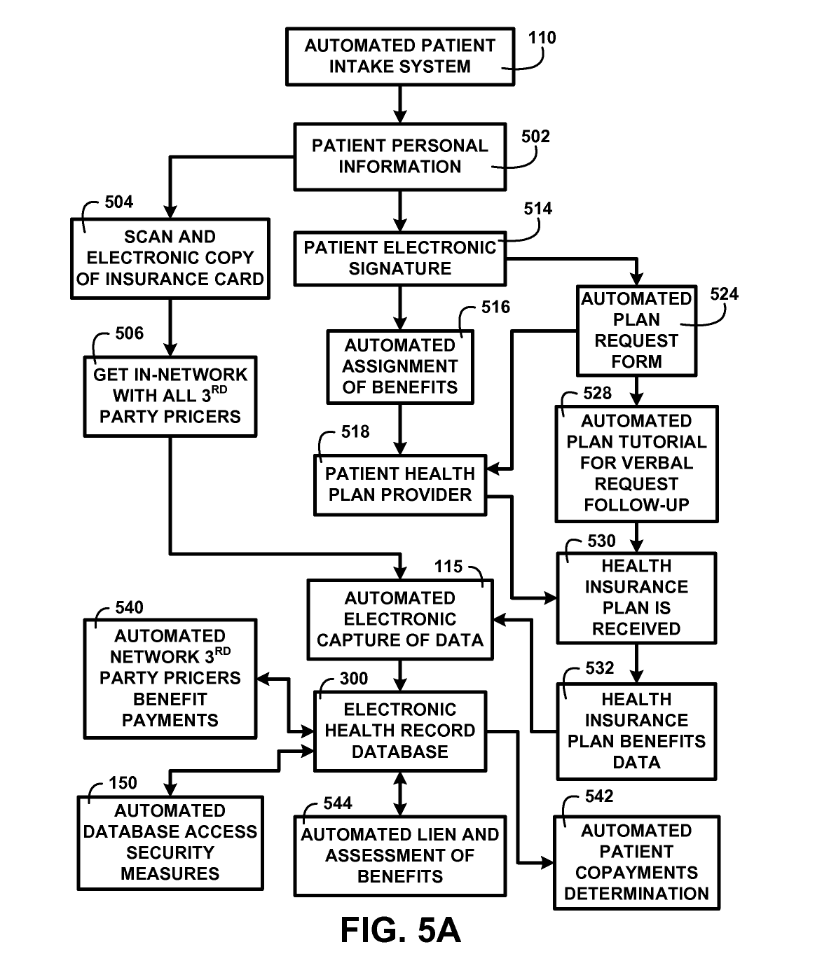

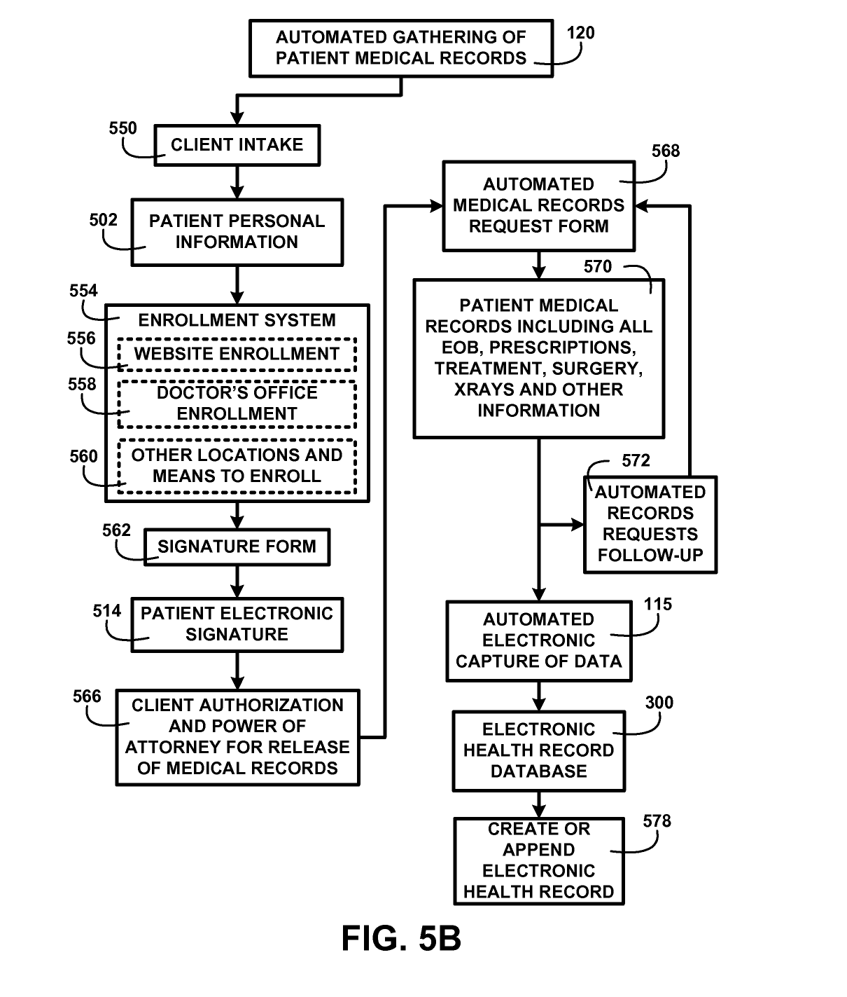

FIG. 5A shows a block diagram of an overview flow chart of an automated patient intake system of one embodiment. FIG. 5A shows the automated patient intake system 110 processing patient personal information 502 for example a scan and electronic copy of insurance card 504. This information is used to get in-network with all 3rd party pricers 506 using the automated electronic capture of data 115. The patient personal information 502 includes a patient electronic signature 514 to authorize access by the health provider to the information and an automated assignment of benefits 516 from a patient health plan provider 518 of one embodiment.

The patient electronic signature 514 is used to create an automated plan request form 524 which is automatically sent to the patient health plan provider 518. The automated patient intake system 110 includes an automated plan tutorial for verbal request follow-up 528 for health provider staff use. When a health insurance plan is received 530 health insurance plan benefits data 532 is processed using the automated electronic capture of data 115 and recorded in the electronic health record database 300. The health insurance plan benefits data 532 is processed including automated network 3rd party pricers benefit payments 540, automated patient copayments determination 542 and automated lien and assessment of benefits 544 and coded using the automated database access security measures 150. Other patient intake processing is described in FIG. 5B of one embodiment.

### Automated Gathering Patient Medical Records:

FIG. 5B shows a block diagram of an overview flow chart of an automated gathering patient medical records of one embodiment. FIG. 5B shows the automated gathering patient medical records 120 using client intake 550 processing patient personal information 502. The patient personal information 502 is used in a enrollment system 554 including website enrollment 556, doctor's office enrollment 558 and other locations and means to enroll 560. The automated gathering patient medical records 120 includes generating automatically a signature form 562 with the patient electronic signature 514. The signature form 562 is used to create a client authorization and power of attorney for release of medical records 566 that will accompany an automated medical records request form 568 of one embodiment.

The automated medical records request form 568 is used to request patient medical records including all EOB, prescriptions, treatment, surgery, x-rays and other information 570. If the automated medical records request form 568 when not received in a timely fashion the automated gathering patient medical records 120 generates an automated records requests follow-up 572. When the automated medical records request form 568 is responded to the information received is processed using the automated electronic capture of data 115. The information received is entered into the electronic health record database 300 to create or append electronic health record 578 of one embodiment.

### Automated Patient Insurance Verification System:

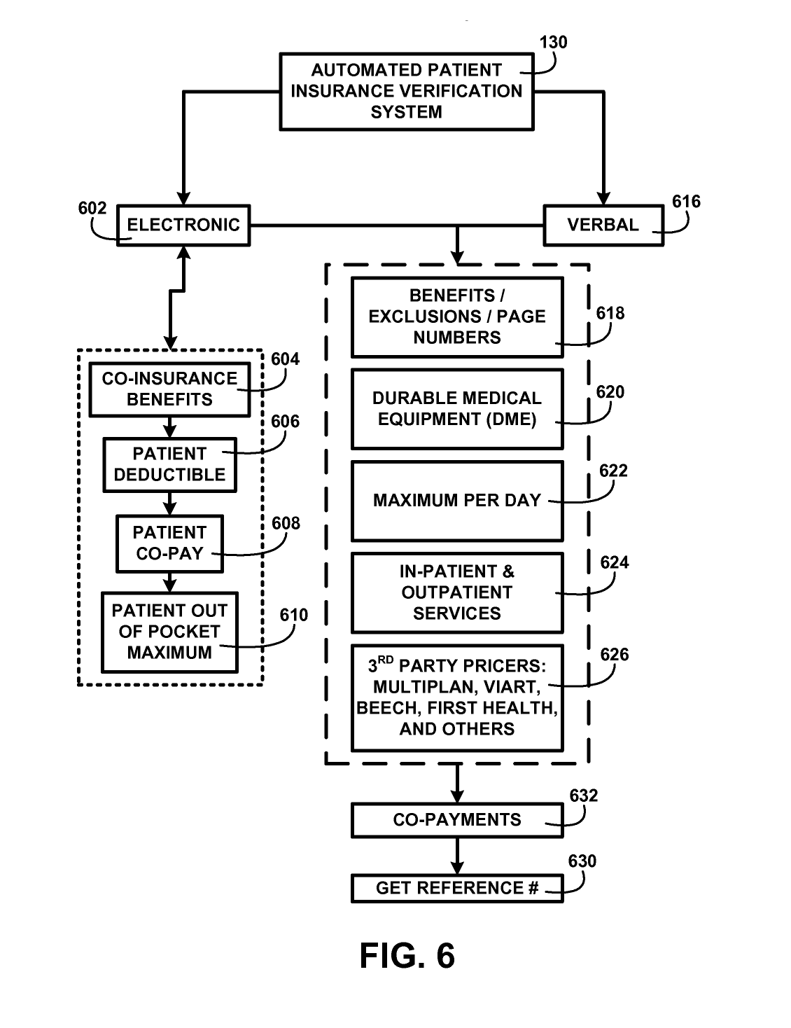

FIG. 6 shows a block diagram of an overview flow chart of an automated patient insurance verification system of one embodiment. FIG. 6 shows the automated patient insurance verification system 130 includes electronic 602 and verbal 616 capture of insurance benefits. The electronic 602 capture of co-insurance benefits 604 including patient deductible 606, patient co-pay 608 and patient out of pocket maximum 610. The electronic 602 capture and verbal 616 capture of benefits information is entered into the electronic health record database 300 of FIG. 3. The benefits information entered includes benefits/exclusions/page numbers 618, durable medical equipment (DME) 620, maximum per day 622, in-patient & outpatient services 624 and 3rd party pricers: Multiplan, Viart, Beech, First Health, and others 626. The electronic 602 and verbal 616 captures of insurance benefits includes co-payments 632 of the patient. The automated patient insurance verification system 130 includes recording of a reference # verifying the benefits and a reminder to get reference #630 when the information is captured using a verbal 616 inquiry of one embodiment.

### Automated Preauthorization and Appeal Benefit Determination System:

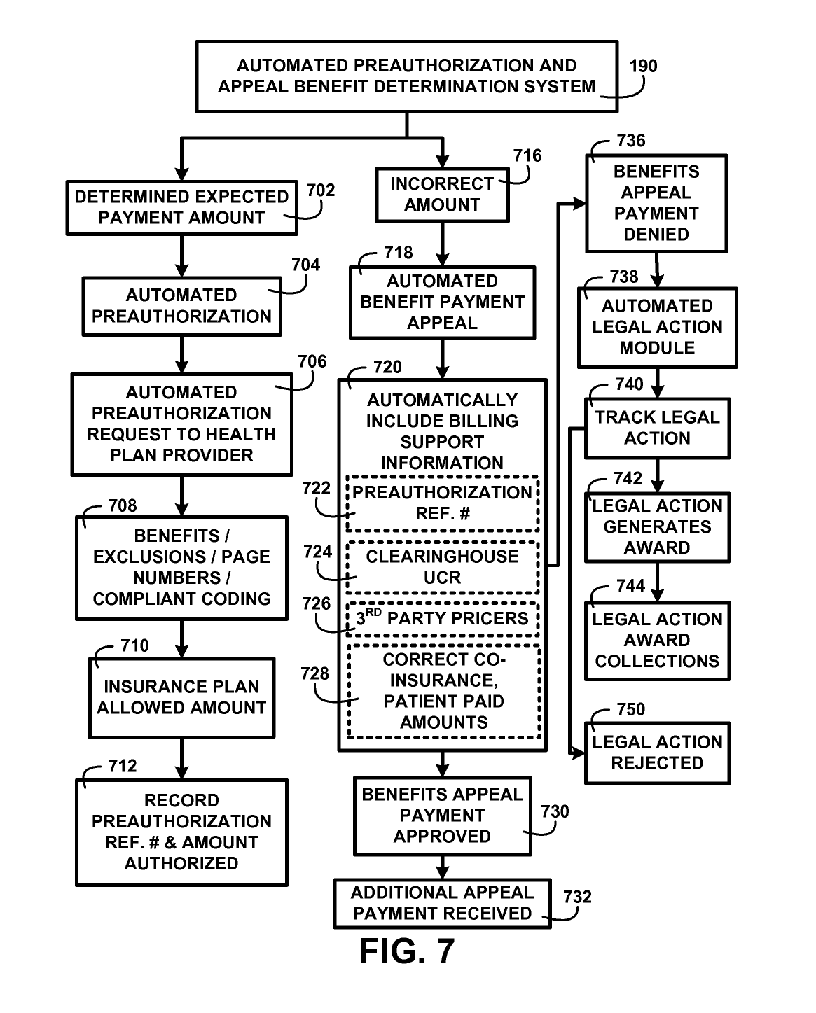

FIG. 7 shows a block diagram of an overview flow chart of an automated preauthorization and appeal benefit determination system of one embodiment. FIG. 7 shows the automated preauthorization and appeal benefit determination system 190 is used to automatically assess a determined expected payment amount 702 using the captured benefits information for a patient treatment or procedure. The automated preauthorization and appeal benefit determination system 190 processes an automated preauthorization 704 using an automated preauthorization request to health plan provider 706. The automated preauthorization and appeal benefit determination system 190 records the benefits/exclusions/page numbers/compliant coding 708 and insurance plan allowed amount 710. The automated preauthorization and appeal benefit determination system 190 proceeds to record preauthorization ref. # & amount authorized 712 of one embodiment.

When a health plan provider pays an incorrect amount 716 the automated preauthorization and appeal benefit determination system 190 processes an automated benefit payment appeal 718. The automated benefit payment appeal 718 is used to automatically include billing support information 720 and a preauthorization ref. #722. The billing support information can include clearinghouse UCR 724 as a Usual, Customary and Reasonable payment, 3rd party pricers 726 payment amounts, correct co-insurance and patient paid amounts 728. The automated benefit payment appeal 718 may result in a benefits appeal payment approved 730 and additional appeal payment received 732 of one embodiment.

The automated benefit payment appeal 718 may result in a benefits appeal payment denied 736. If denied the automated preauthorization and appeal benefit determination system 190 uses an automated legal action module 738 to process a legal action. The automated legal action module 738 is used to track legal action 740. When a legal action generates award 742 the automated legal action module 738 processes a legal action award collections 744 protocol. The automated benefit payment appeal 718 may result in a legal action rejected 750 which ends the appeals process of one embodiment.

### Automated Electronic Health Billing and Coding System:

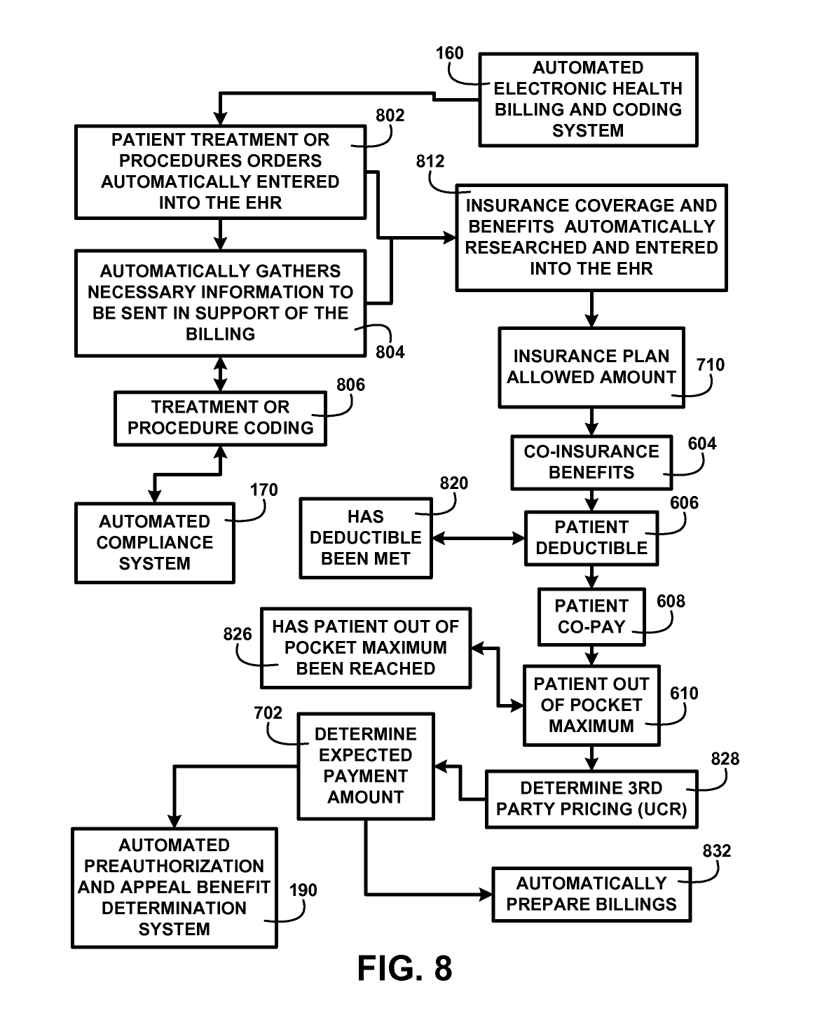

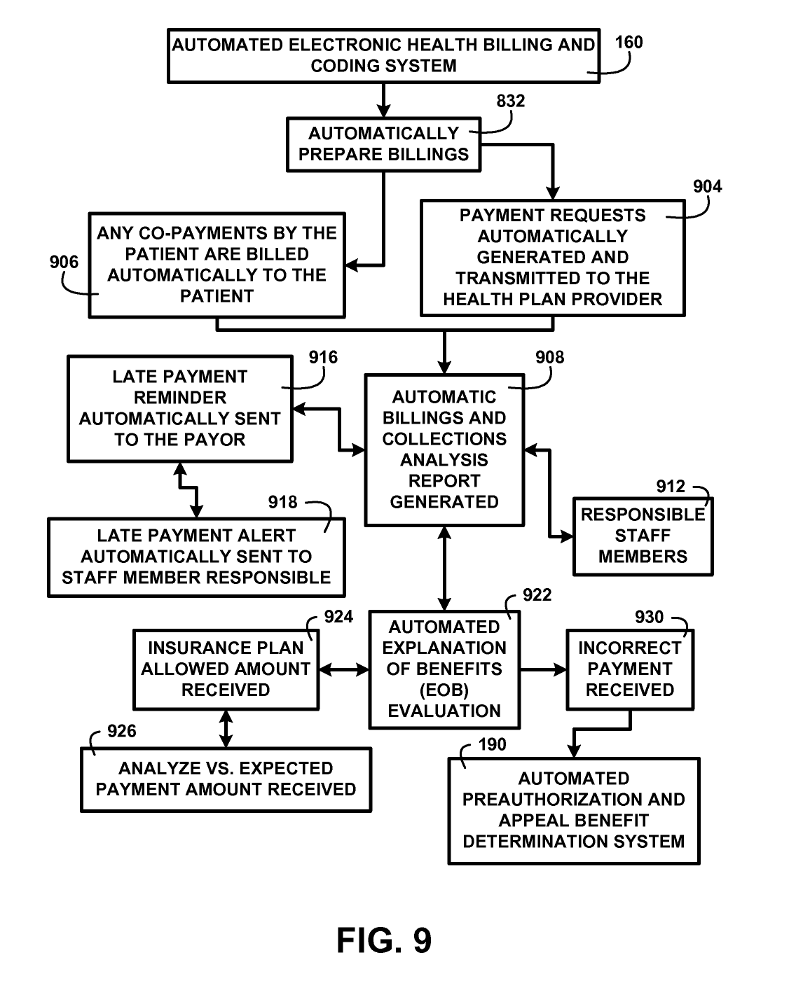

FIG. 8 shows a block diagram of an overview flow chart of an automated electronic health billing and coding system of one embodiment. FIG. 8 shows the automated electronic health billing and coding system 160 used to prepare billing for patient treatment or procedures orders automatically entered into the EHR 802. The automated electronic health billing and coding system 160 automatically gathers necessary information to be sent in support of the billing 804. Treatment or procedure coding 806 is automatically confirmed using the automated compliance system 170. The automated electronic health billing and coding system 160 is used wherein insurance coverage and benefits automatically researched and entered into the EHR 812 are used to determine the insurance plan allowed amount 710. Included in the billing are the co-insurance benefits 604, patient deductible 606 and has deductible been met 820, the patient co-pay 608 and patient out of pocket maximum 610 and has patient out of pocket maximum been reached 826. The automated electronic health billing and coding system 160 uses the automated preauthorization and appeal benefit determination system 190 to determine 3rd party pricing (UCR) 828 and proceeds to automatically prepare billings 832. The automatic preparation of billings is further described in FIG. 9 of one embodiment.

### Automatically Prepared Billings:

FIG. 9 shows a block diagram of an overview flow chart of an automated electronic health billing and coding system of one embodiment. FIG. 9 shows the automated electronic health billing and coding system 160 processes used to automatically prepare billings 832. The automated electronic health billing and coding system 160 processes payment requests automatically generated and transmitted to the health plan provider 904. The processes to automatically prepare billings 832 include any co-payments by the patient are billed automatically to the patient 906.

The automated electronic health billing and coding system 160 includes processes wherein an automatic billings and collections analysis report generated 908 and distributed to responsible staff members 912. The processes to automatically prepare billings 832 include a late payment reminder automatically sent to the payor 916 wherein a late payment alert automatically sent to staff member responsible 918 of one embodiment.

The automated electronic health billing and coding system 160 includes an automated explanation of benefits (EOB) evaluation 922 showing an insurance plan allowed amount received 924 including a process to analyze vs. expected payment amount received 926. If an incorrect payment received 930 it is automatically reported to the automated preauthorization and appeal benefit determination system 190 of one embodiment.

### Automated Compliance System:

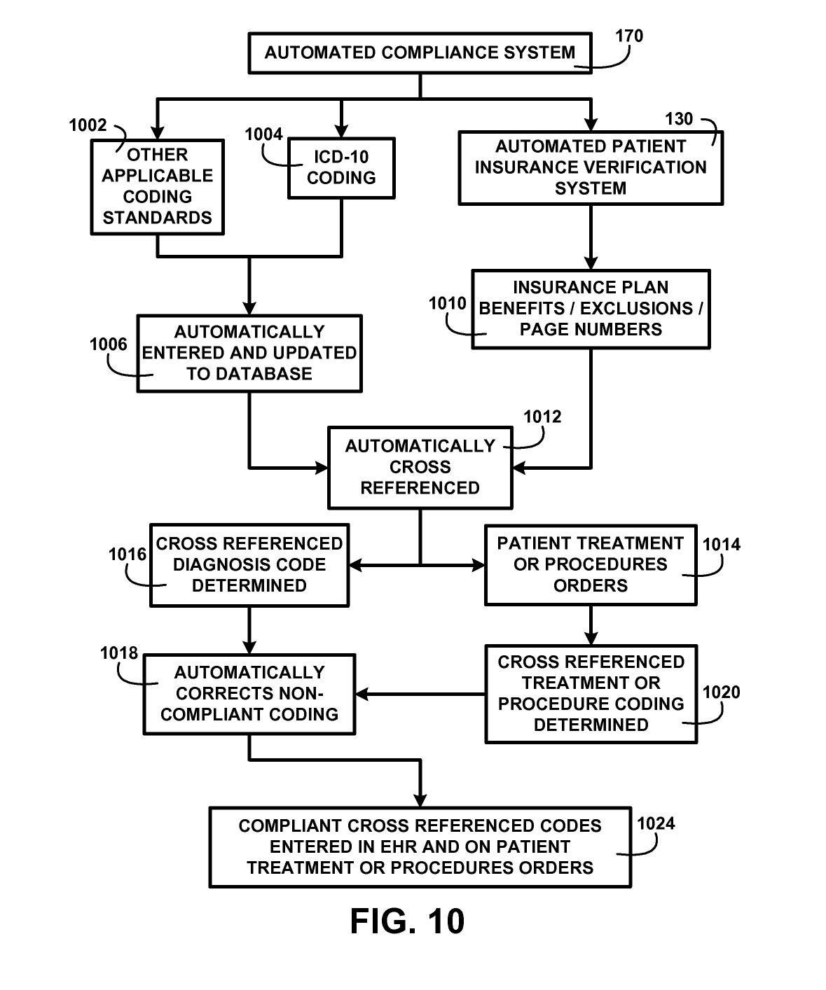

FIG. 10 shows a block diagram of an overview flow chart of an automated compliance system of one embodiment. FIG. 10 shows the automated compliance system 170 including ICD-10 coding 1004 and other applicable coding standards 1002 which are automatically entered and updated to database 1006. The automated compliance system 170 references the automated patient insurance verification system 130 insurance plan benefits/exclusions/page numbers 1010 which are automatically cross referenced 1012 with the respective codes. A cross referenced diagnosis code determined 1016 is entered onto patient treatment or procedures orders 1014. The patient treatment or procedures orders 1014 include a cross referenced treatment or procedure coding determined 1020. The automated compliance system 170 automatically corrects non-compliant coding 1018. The automated compliance system 170 is used wherein compliant cross referenced codes entered in EHR and on patient treatment or procedures orders 1024 of one embodiment.

### Automated Patient Collection System:

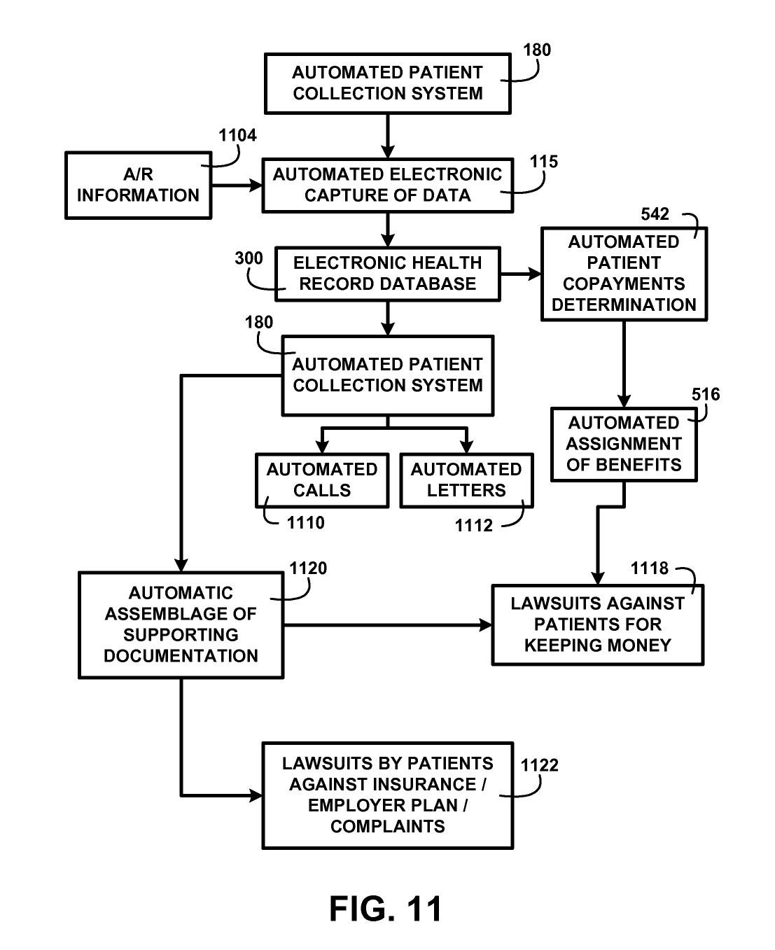

FIG. 11 shows a block diagram of an overview flow chart of an automated patient collection system of one embodiment. FIG. 11 shows the automated patient collection system 180 wherein accounts receivable A/R information 1104 is entered using the automated electronic capture of data 115. The A/R information 1104 is recorded in the electronic health record database 300. The automated patient collection system 180 includes using automated calls 1110 and automated letters 1112 in the collection efforts. An automated patient copayments determination 542 is processed to collect those amounts from the patient. If a patient keeps any amounts related to the automated assignment of benefits 516 the automated patient collection system 180 automatically processes lawsuits against patients for keeping money 1118. The automated patient collection system 180 processes automatic assemblage of supporting documentation 1120 for use in lawsuits by patients against insurance/employer plan/complaints 1122 of one embodiment.

### Automatic Billings and Collections Analysis Report Generated:

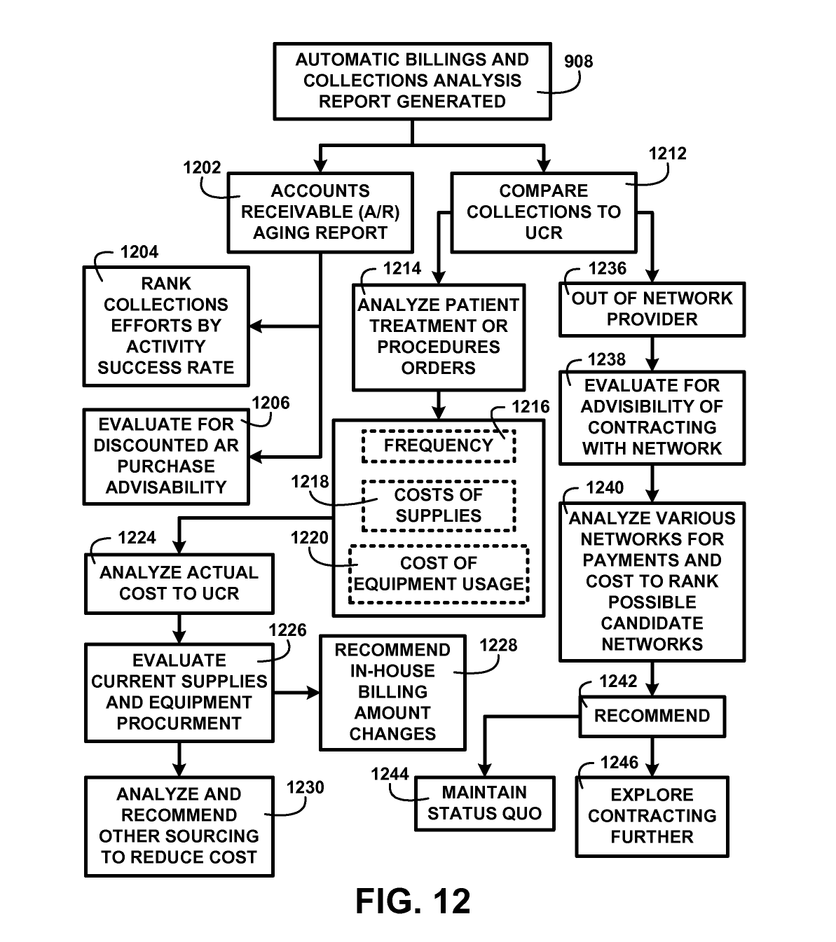

FIG. 12 shows a block diagram of an overview flow chart of an automatic billings and collections analysis report generated of one embodiment. FIG. 12 shows the automatic billings and collections analysis report generated 908 including accounts receivable (A/R) aging report 1202. The automatic billings and collections analysis report generated 908 includes a process used to rank collections efforts by activity success rate 1204 and evaluate for discounted A/R purchase advisability 1206. The automatic billings and collections analysis report generated 908 is used to compare collections to UCR 1212, analyze patient treatment or procedures orders 1214 for frequency 1216, costs of supplies 1218 and cost of equipment usage 1220 of one embodiment.

The automatic billings and collections analysis report generated 908 is used to analyze actual cost to UCR 1224, evaluate current supplies and equipment procurement 1226, recommend in-house billing amount changes 1228 and analyze and recommend other sourcing to reduce cost 1230. The automatic billings and collections analysis report generated 908 are used to compare collections to UCR 1212 for an out of network provider 1236 and evaluate for advisability of contracting with network 1238. The evaluation of contracting with a network includes processes to analyze various networks for payments and cost to rank possible candidate networks 1240 and recommend 1242 actions to maintain status quo 1244 or explore contracting further 1246 of one embodiment.

### Automated Explanation of Benefits (EOB) Evaluation:

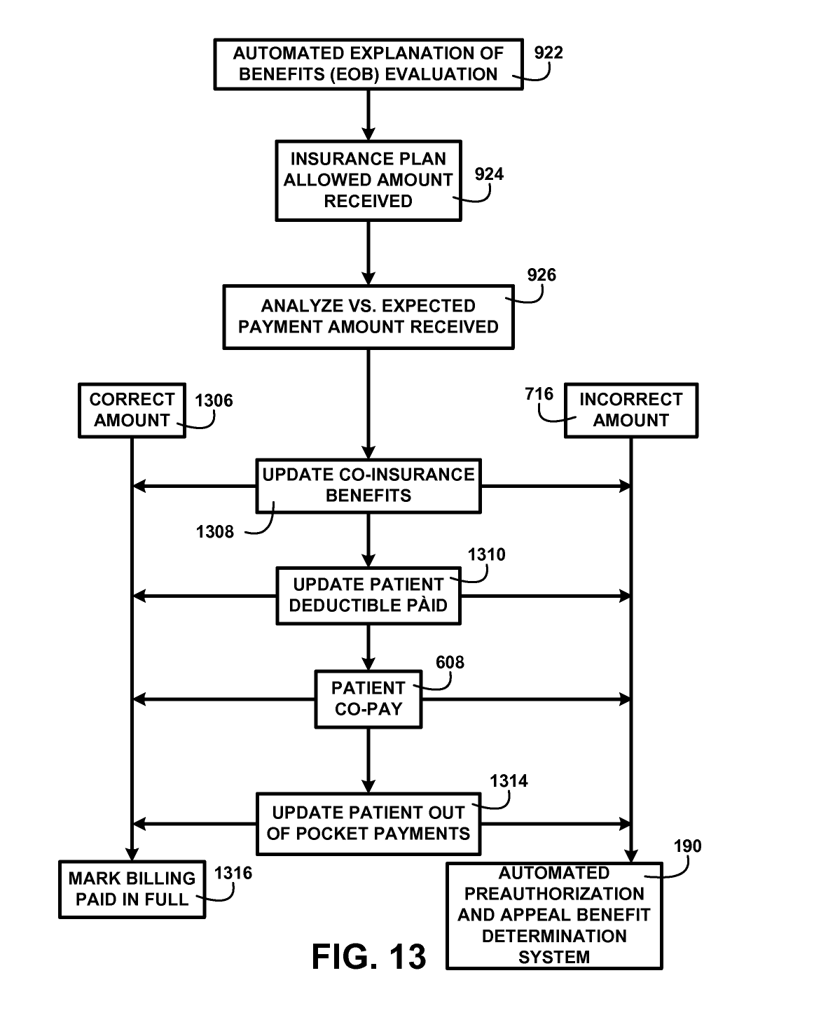

FIG. 13 shows a block diagram of an overview flow chart of an automated explanation of benefits (EOB) evaluation of one embodiment. FIG. 13 shows the automated explanation of benefits (EOB) evaluation 922 is used to evaluate the insurance plan allowed amount received 924 and analyze vs. expected payment amount received 926. The automated explanation of benefits (EOB) evaluation 922 is used to determine a correct amount 1306 or incorrect amount 716 received. The evaluation incorporates the use of an update co-insurance benefits 1308, an update patient deductible paid 1310, the amount of patient co-pay 608 and an update patient out of pocket payments 1314. If the amount received is the correct amount 1306 a process is used to mark billing paid in full 1316. If the amount received is an incorrect amount 716 the collection is automatically referred to the automated preauthorization and appeal benefit determination system 190 of one embodiment.

The foregoing has described the principles, embodiments and modes of operation. However, the invention should not be construed as being limited to the particular embodiments discussed. The above described embodiments should be regarded as illustrative rather than restrictive, and it should be appreciated that variations may be made in those embodiments by workers skilled in the art without departing from the scope as defined by the following claims.

What is claimed is:

1. A method of automated electronic health record system, comprising:
automating the collection, recordation, storage and use patient health information and data to create an electronic health record in a secure electronic environment;
using one or more automated systems to facilitate the rapid and accurate collection, storage and use of the electronic health record information and data including automated database access security measures; and
querying the electronic health record information and data using the one or more automated systems to prepare and process patient billing, health insurance billings and collections and cross check the electronic health record information and data with current governmental and agency compliance and other health related processing.

2. The method of claim 1, wherein the automated electronic health record system is configured to include using digital devices to collect, record, store and use patient health information and data to create, update and maintain an electronic health record.

3. The method of claim 1, wherein one or more automated systems include using an automated electronic health record system, automated electronic capture of data, automated database access security measures, automated patient intake system, automated gathering patient medical records, automated patient insurance verification system, automated preauthorization and appeal benefit determination system, automated electronic health billing and coding system, automated electronic health billing and coding system, automated compliance system, automated patient collection system and other automated systems and processes.

4. The method of claim 3, wherein the automated patient intake system is configured to create a patient electronic health record using automated intake systems.

5. The method of claim 1, wherein the automated patient insurance verification system is configured to verify the current status and specific information of a patient health insurance plan using automated systems and record the verified health insurance plan information in the patient file stored in an automated database.

6. The method of claim 1, wherein the automated preauthorization and appeal benefit determination system is configured to request and secure preauthorization of a medical treatment or procedure and also using the automated systems to appeal an insurance carrier benefit determination.

7. The method of claim 1, wherein the automated electronic health billing and coding system is configured to include querying the patient electronic health record and preparing billings including proper coding to the patient's health insurance carrier and/or patient for preauthorized medical procedures.

8. The method of claim 1, wherein the automated compliance system is configured to include cross checking patient electronic health record information for compliance with automatically downloaded compliance codes.

9. The method of claim 1, wherein the automated patient collection system is configured to include tracking and processing payments for patient billings from patients and patient health insurance plan carriers.

10. The method of claim 1, wherein the automated gathering patient medical records is configured to include automatically assembling patient medical records past and present from multiple health care providers, multiple patient health insurance plans and carriers to record and store in the patient electronic health record.

11. An apparatus, comprising:
means for automated electronic capture of patient information and data to create an electronic health record database;
means for automated systems to access the electronic health record database to process and maintain patient information and data; and;
means for automated database access security measures to protect the privacy of patient information and data stored and maintained in the electronic health record database.

12. The apparatus of 10, further comprising means for the automated electronic capture of patient information and data using digital devices and electronic devices and systems to collect, record, store and use patient health information and data to create, update and maintain an electronic health record.

13. The apparatus of 10, further comprising means for the automated systems to access the electronic health record database to process and maintain patient information and data including using an automated electronic health record system, automated electronic capture of data, automated database access security measures, automated patient intake system, automated gathering patient medical records, automated patient insurance verification system, automated preauthorization and appeal benefit determination system, automated electronic health billing and coding system, automated electronic health billing and coding system, automated compliance system, automated patient collection system and other automated systems and processes.

14. The apparatus of 10, further comprising means for the automated database access security measures including multi-character codes to provide storage of vast amounts of data files, automated coding of patient information, frequent automated encrypted password changes, automated monitoring of database access and data transfers, limited authorized access to electronic health record database coded descriptions of patient information and coded data in patient records.

15. The apparatus of 10, further comprising means for the data query of the electronic health record database.

16. The apparatus of 10, further comprising means for the automation of controls to activate digital devices automatically.

17. An automated electronic health record system, comprising:
coding patient information and medical records inputted and stored in an electronic health record database for easy access by automated systems; and
automating the intake, gathering, data query and processing of coded patient information and medical records in the electronic health record database.

18. The automated electronic health record system of claim 17, further comprising a system to limit database access to authorized users configured to include automated database access security measures.

19. The automated electronic health record system of claim 17, further comprising a system to automate the intake, gathering, data query and processing of coded patient information and medical records configured to include automated electronic capture of patient information and data using digital devices and electronic devices and systems to collect, record, store and use patient health information and data to create, update and maintain an electronic health record.

20. The automated electronic health record system of claim 17, further comprising a system to access the electronic health record database by automated systems configured to include using an automated electronic capture of data, an automated database access security measures, an automated patient intake system, an automated gathering patient medical records, an automated patient insurance verification system, an automated preauthorization and appeal benefit determination system, an automated electronic health billing and coding system, an automated electronic health billing and coding system, an automated compliance system, an automated patient collection system and other automated systems and processes.
